(19) United States
(12) Patent Application Publication
(10) Pub. No.: US 2025/0077934 A1
(43) Pub. Date: Mar. 6, 2025

(54) MACHINE LEARNING RANKING DISTILLATION

(71) Applicant: Google LLC, Mountain View, CA (US)

(72) Inventors: Gil Shamir, Sewickley, PA (US); Zhuoshu Li, Pittsburgh, PA (US)

(21) Appl. No.: 17/927,105

(22) PCT Filed: Sep. 23, 2022
(86) PCT No.: PCT/US2022/044479

§ 371 Date: Nov. 22, 2022

(30) Foreign Application Priority Data
Oct. 13, 2021 (IL) 287233

(51) Int. Cl. G06N 20/00

(52) U.S. Cl. CPC G06N 20/00

(57) ABSTRACT

Methods, systems, and apparatus, including computer programs encoded on a computer storage medium for training and using distilled machine learning models. In one aspect, a method includes obtaining a first input that includes training example sets that each include one or more feature values and, for each item, an outcome label that represents whether the item had a positive outcome. A first machine learning model is trained using the first input and is configured to generate a set of scores that represents whether the item will have a positive outcome when presented in the context of the training example set and with each other item in the example set. A distilled machine learning model is trained using the set of scores for each example set. The distilled machine learning model is configured to generate a distilled score.

### TECHNICAL FIELD

This specification relates to machine learning knowledge distillation for recommendation systems.

### BACKGROUND

Training and evaluating complex machine learning models, such as deep neural networks (DNNs), can be computationally complex, requiring powerful computers to complete. While such models can produce extremely accurate results, in computationally constrained environments, such as mobile phones or personal computers, it is not computationally feasible to use such models.

### SUMMARY

In general, this specification describes machine learning knowledge distillation techniques that improve ranking accuracy while preserving prediction accuracy.

Improving the accuracy of rankings is important in recommendation systems—that is, systems that predict ratings or other scores for each item in a set of items based on one or more metrics related to the items, their intended use, past performance in that use, their users, etc., and utilize those ratings to provide recommendations. For example, given appropriate data about defects in a component produced by a manufacturing process, a properly trained recommendation system can provide a ranked set of automated sets of processes that can be used to correct the defect, and the highest-ranked alternative can be attempted first. Note that, in such cases, the ranking of the alternatives can be more important than the actual scores since the highest ranked alternatives will often be attempted first.

The knowledge distillation techniques described in this document can also be used to improve the display of interactive content. For example, when determining which digital component to display, e.g., in conjunction with search results or other digital content, and in what position, the ranking of the candidate digital components can be more important (or just as important) than the actual score produced by a machine learning model used to predict the performance (e.g., interaction rate) of the digital components. The digital component ranked highest can be displayed in the most prominent position, and successively lower ranked digital components can be displayed in less prominent positions.

Particular embodiments of the subject matter described in this specification can be implemented so as to realize one or more of the following advantages. The techniques described in this document can be used in a recommendation system to both rank and score items accurately using a distilled machine learning model (which can also be referred to as a student model) that requires fewer computational resources than a corresponding teacher model, allowing the recommendations to be supplied by computers possessing less compute capability as compared to the computers required to process data using a teacher model. In addition, the techniques below can be used in a recommendation system to compute scores and rankings in less time than using a teacher model, allowing responses to be provided rapidly and at large scale. This also enables the distilled machine learning models to be used in situations in which outputs need to be provided quickly, such as on assembly lines and in the context of transmitting digital content (e.g., content that includes images and/or videos) to client devices, where excess latency can cause errors at the user device while waiting for content. Using a robust teacher model to train a distilled machine learning model can provide these performance improvements without loss, or with minimal loss, of accuracy in ranking items. Further, the techniques described below, and particularly the listwise loss computation techniques, result in a more efficient implementation—that is, one that requires fewer processor instructions to complete. In addition, using the techniques described below, a teacher model that does not satisfy various system constraints can be trained to provide an even stronger signal. Then, the deployed model, one that must satisfy such constraints, can still leverage the signal of the teacher model to improve its performance despite these constraints. Additionally, due to complexity and/or system requirements, a student model may not be capable of training over many of the data examples, such as in distributed systems, where the student model is one node, but the teacher is a centralized model (e.g., federated learning). Using the techniques described below, the teacher can train over datasets that the student is incapable of training over, while still providing the student with the ability to benefit from such examples, including accurate rankings.

In general, one innovative aspect of the subject matter described in this specification can be embodied in methods that include obtaining a first input that includes training example sets that each include, for a set of items, one or more feature values that represent features of a context in which each item in the set of items were recommended and, for each item, an outcome label that represents whether the item had a positive outcome. A first machine learning model is trained using the first input. The first machine learning model is configured to generate a set of scores for each training example set, where the set of scores for each training example set can include, for each item in the training example set, a training score that represents whether the item will have a positive outcome when presented in the context of the training example set and with each other item in the example set. A distilled machine learning model is trained using the set of scores for each example set. The distilled machine learning model is configured to generate, for each item in an actual set of items, a distilled score that represents: (i) whether the item will have a positive outcome when presented in a given context and with each other item in the actual set of items, and (ii) the ranking of the item in the actual set of items. A positive outcome can indicate that a particular action occurred with respect to the item when the item was selected for deployment to a device. Other embodiments of this aspect include corresponding systems, apparatus, and computer programs, configured to perform the actions of the methods, encoded on computer storage devices.

These and other implementations can each optionally include one or more of the following features. Each item can be a digital component. A training system can provide the distilled model to a recommendation system that distributes digital components. The recommendation system can determine digital components to provide to client devices in response to requests received from the client devices determining, and provide the selected digital components to the client devices.

The distilled machine learning model can trained using, for each item of the training example sets: (i) a true label corresponding to the outcome label for the item; (ii) a comparison between a distilled model score for the item with a teacher model score for the item; and (iii) a comparison between a ranking of the item among the items of the plurality of training example sets with the true label for each item; and item-wise score differences between training examples within a same training example set. The loss can be L2 loss.

Training the distilled machine learning model can include determining item-wise score differences between training examples within a same training example set; and minimizing a loss corresponding to the item-wise score differences.

Training the distilled machine learning model can include determining each item-wise score difference by, for each pair of items in the same training example set: (i) determining a first difference between a first teacher model score for a first item of the pair of items and a second teacher model score for a second item of the pair of items; (ii) determining a second difference between a first distilled model score for the first item and a second distilled model score for the second item of the pair of items; and (iii) determining, as the item-wise score difference for the pair of items, a difference between the first difference and the second difference.

Training the distilled machine learning model can include reducing an aggregate of the item-wise score differences for each training example set.

Training the distilled machine learning model can include determining item-wise score differences by, for a first item in a list of items in the same training example set and for each second item in a list of items in the same training example set, where the first item is different from the second item: (i) determining a first difference between a first teacher model score for a first item and a second teacher model score for the second item, (ii) determining a second difference between a first distilled model score for the first item and a second distilled model score for the second, and (iii) determining an individual loss value based on the first difference and the second difference; and determining the list-wise loss value based on the individual loss values.

Training the distilled machine learning model can include reducing an aggregate of the list-wise loss values for each training example set. Each item-wise score difference can be a pairwise score difference or a listwise score difference.

Training the distilled machine learning model can include computing, as a loss function, a summing, across all items of the plurality of training example sets, a square of a difference between losses computed for the item.

Training the distilled machine learning model can include determining a loss function, based on, for each item of the plurality of training example sets, a comparison between an outcome for the item predicted by the distilled model and an actual outcome for the item represented by the outcome label for the item.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram of an example data flow for generating and using a distilled machine learning model to provide recommendations.

FIG. 1B is a diagram of an example environment in which a distillation recommendation system uses a distilled machine learning model to provide recommendations.

FIG. 2 is a flow diagram of an example process for training and providing a distilled machine learning model.

FIG. 3 is a flow diagram of an example process for providing results to a query using a distilled machine learning model.

FIG. 4 is a block diagram of an example computer system.

Like reference numbers and designations in the various drawings indicate like elements.

### DETAILED DESCRIPTION

Knowledge distillation can be applied to machine learning models, including deep neural networks (DNNs), to extract information captured by training a complex (or more knowledgeable) teacher model and transferring that knowledge to a student model that is simpler and therefore requires less computational resources to evaluate. While training the teacher model can require a large investment in computing resources, using knowledge distillation, the student model can be deployed to perform inferences on devices with more limited resources, and still produce results that are nearly as accurate as the results that would have been produced by the teacher model.

However, with less knowledge available, the student models can be less accurate in their predictions than the teacher model. In some cases, the inaccuracy can lead to inaccurate rankings of results. For example, consider a case where the teacher model produces a score of 0.669 for one example, and 0.667 for a second example, and the student model produced scores of 0.667 and 0.668. In this example, while the scores produced by the student model are quite similar to the scores produced by the teacher model, the ranking of the scores is incorrect: in the teacher model, the first set of feature data is ranked ahead of the second set of feature data, while in the student model, the second set of feature data is ranked ahead of the first set of feature data.

In the context of recommendation systems, an objective that may be equally or more important than accuracy is that of properly ranking examples. Optimizing for this objective, however, should not deteriorate prediction accuracy. The systems and techniques described in this document for ranking knowledge distillation from a powerful or more knowledgeable teacher model to a simpler or less knowledgeable can be applied together with optimization and distillation for prediction accuracy.

In recommendation systems, such as distributing digital components with interaction rate prediction or content/document recommendations, ranking the items according to a likely positive outcome can be as important or more important than predicting the probability of such an outcome. For example, such systems can only show the top-k ranked items to a user, and the position in which an item is shown also impacts the outcome if more items with more favorable outcomes are shown in better positions. If ranking is incorrect, the outcomes may thus not be the best ones. Absent the techniques described in this document, a system could train on individual examples (or items) without the ability to consider interactions or effects between items that are provided (e.g., displayed) together in response to a user request. For some applications, both an accurate prediction of the label and accurate ranking of the outcomes are important. For interaction rates for digital components provided to users, ranking can determine which digital component is shown to the user, while accurate label probability prediction is important for determining an amount required to be provided to the publisher for displaying the digital component.

Recommendation systems can train on labeled data. For example, cross entropy loss on the label can be used to train the probability of a label of a certain example. Training for the label probability, in many cases, does not account for the ranking of one example relative to the other. Neither does it account for interactions between multiple examples, which are jointly displayed in response to some query. If the model is correctly specified, good accuracy of predicting the probability of the label can also carry over to ranking. However, real models can mis-specify in the sense that some features that affect the label outcomes may not be available to the designer. This can lead to predictions that marginalize over the unavailable features. This may lead to situations that correct ranking may not always agree with the label prediction which leads to the best average accuracy. For example, item A can have a higher expected positive label than item B over all their occurrences. However, when they appear together (in a small fraction of examples), B will always have a more positive outcome.

Thus, while the positive marginal rate of A is higher, when they are shown on the same set together, B should be ranked higher than A.

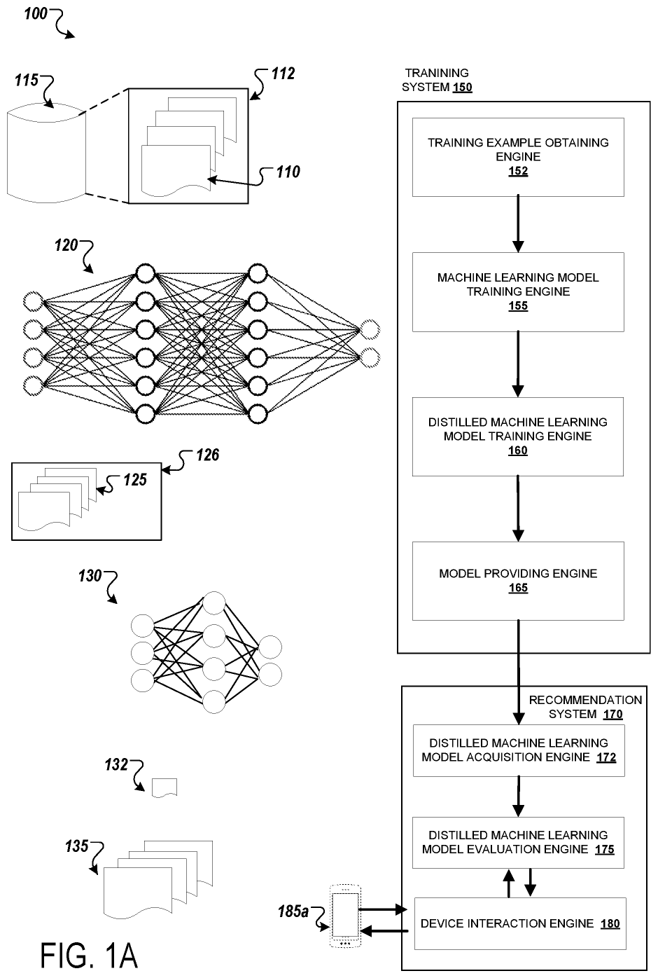

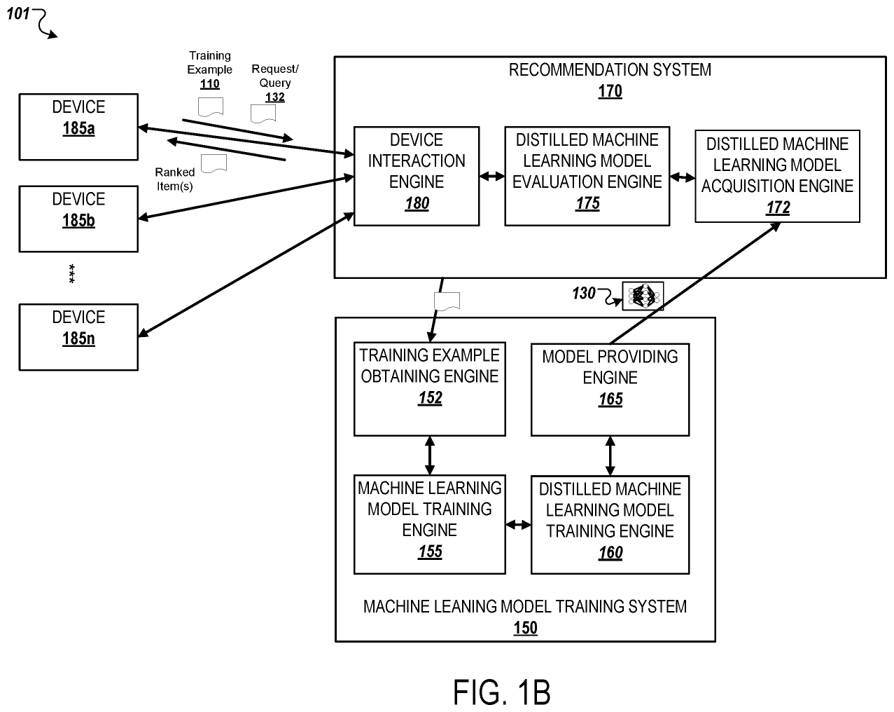

FIG. 1A is a diagram of an example data flow 100 for generating and using a distilled machine learning model to provide recommendations. FIG. 1B is a diagram of an example environment 101 in which a distillation recommendation system uses a distilled machine learning model to provide recommendations.

Knowledge distillation can include distilling (transferring) predictions from the predictions (or scores) of an expensive or data rich teacher model to a less computationally complex student model. Ranking distillation techniques described in this document is a form of knowledge distillation that can include distilling (transferring) ranking predictions from the predictions (or scores) of an expensive or data rich teacher model to a less computationally complex student model, which can be referred to as a distilled machine learning model.

The ranking between two items depends on the relationship between the scores reflecting the outcomes of the two items. In some implementations, if the score of a first item is higher than the score of a second item, the first item is ranked higher, and vice-versa. However, the scores do not always reflect which of multiple items will receive a positive outcome when both items are provided together as recommendations.

In recommendation systems, the outcomes are generally binary: an item is selected (positive outcome) or an item is not selected (negative outcome). When comparing rankings in such cases, if first item is selected and a second item is not, the comparison outcome label is 1 for the first item; if the second item is selected and the first is not, the comparison outcome label is 0 for the first item; and if both items are either selected or not selected, the comparison outcome label is 0.5 for both items. In some cases, the latter examples can be omitted from the calculation. Note that similar label mappings can be derived from the standpoint of the second item.

This document describes a framework that distills rankings from the teacher model to the student model and is agnostic to the actual score of a given example. Training for the actual score can be addressed by the accuracy loss of the model, and, in some implementations, by an additional level of conventional distillation loss minimization used to improve accuracy.

The example environment 100 for ranking distillation includes a machine learning model training system 150 (also referred to as “training system” 150 for brevity) and a recommendation system 170. The training system 150 includes a training example obtaining engine 152, a machine learning model training engine 155, a distilled machine learning model training engine 160, and a model providing engine 165.

The recommendation system 170, which can be implemented using one or more computers in one or more locations, can provide recommendations, e.g., in response to requests 132. The recommendations can include a set of recommended items, which can be ordered based on a ranking. In some implementations, the recommendation system 170 can provide a single recommended item based on the order.

The recommendation system 170 can be used in various environments or contexts and recommend different items based on the environment or context. For example, in the context of a manufacturing facility, the recommendation system 170 can recommend tasks or processes to fix or improve a component. In another example, the recommendation system 170 can recommend digital content such as electronic resources, e.g., web pages, in response to a query and provide a set of search results that reference the electronic resources. Another example of digital content the recommendation system 170 can recommend is a digital component. For example, the recommendation system 170 can provide digital components for display with other digital content.

As used throughout this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and may include advertising information, video recommendations and so on. For example, the digital component may be content that is intended to supplement content of a web page, application content (e.g., an application page), or other resource displayed by the application. More specifically, the digital component may include digital content that is relevant to the resource content, e.g., the digital component may relate to the same topic as the web page content, or to a related topic. The provision of digital components can thus supplement, and generally enhance, the web page or application content.

The search results and/or digital components can be ordered based on a ranking generated by the recommendation system 170 using a machine learning model, as described in more detail below. If multiple search results or digital components are provided, the search results or digital components can be ordered based on scores output by a machine learning model, as described in more detail below. If only a single search result or digital component is provided, the recommendation system 170 can provide the search result or digital component having the highest score output by the machine learning model.

The training example obtaining engine 152 can acquire training data that includes training examples 110 from a training example data store 115. A training example data store 115 can be any appropriate data storage system, such as a relational database, an unstructured database, a file system, cloud-based storage, and so on.

The training examples 110 can be grouped into training example sets 112. Each training example 110 can correspond to a particular item, e.g., a particular digital component. Each training example set 112 can include, for a set of items (i.e., training examples 110), one or more feature values that represent features of a context in which each item in the set of items were recommended and, for each item, an outcome label that represents whether the item had a positive outcome.

For example, if the recommendation system 170 recommends digital content, the items can be digital components and the features can include features related to a context in which the digital components were displayed. For example, the features can include a resource locator (e.g., Universal Resource Locator (URL) for an electronic resource with which the digital components were displayed, the number of digital component slots on the electronic resource, the geographic location of a device on which the digital components were displayed, a time of day at which the digital components were displayed, keywords of a query for which search results were provided, hyperlinks of the electronic resource, the presence of images on the electronic resource, text size of the electronic resource, the layout of the electronic resource, and so on).

Each training example set 112 can include training examples 110 that were recommended in the same context. For example, each training example set 112 can include training examples 110 for items that were recommended together, e.g., displayed together in the same context. In another example, each training example set 112 can include training examples for items that were recommended in the same context but at different times, e.g., not together. For example, the training example set 112 can include training examples for multiple digital components displayed on a given web page, but at different times and/or to different users.

In some implementations, the outcome label for a training example has a value of zero for a negative outcome and value of one for a positive outcome. Other appropriate values can be used to represent the positive and negative outcomes. In the context of a recommendation system 170, a negative outcome can indicate that an item failed to meet an objective and a positive outcome can indicate that the item satisfied the objective.

If the recommendation system 170 recommends digital content, the outcome label can indicate whether the item corresponding to the training example received a user interaction, e.g., was selected by a user. A positive outcome can indicate that the digital content was selected and a negative outcome can indicate that the digital content was not selected.

If the recommendation system 170 recommends action or processes to fix a component of a manufacturing facility, the outcome label for an item (e.g., the action or process) can indicate whether the action or process was successful in fixing the component.

In another example, feature values can be associated with properties of a component used during a machining operation, such as a drill bit, with feature values including bit length, bit diameter, bit geometry, material to be drilled, angle of the drilling operation, etc. A recommended drill bit can be deemed successful if and only if it met an objective, e.g., drilling in the correct place, to a correct depth and within a specified time.

Table 1 illustrates an example of a training data set that includes training data (TD) for N items in the set, and M features and an outcome (O) for each item.

TABLE 1

| | | | | |
|---|---|---|---|---|
| TD₁₁ | TD₁₂ | . . . | TD_{1M} | O₁ |
| TD₂₁ | TD₂₂ | . . . | TD_{2M} | O₂ |
| TD₃₁ | TD₃₂ | . . . | TD_{3M} | O₃ |
| . . . | . . . | . . . | . . . | . . . |
| TD_{N1} | TD_{N2} | . . . | TD_{NM} | O_{N} |

The training example can be stored in a structured text format such as Extensible markup language (XML) or Javascript Object Notation (JSON), encoded as binary data, or in another appropriate format.

TABLE 2

| | | | | |
|---|---|---|---|---|
| TD₁₁₁ | TD₁₁₂ | . . . | TD_{11M} | O₁₁ |
| TD₁₂₁ | TD₂₂ | . . . | TD_{2M} | O₁₂ |
| . . . | . . . | . . . | . . . | . . . |
| TD_{1N1} | TD_{1N2} | . . . | TD_{1NM} | O_{1N} |
| TD₂₁₁ | TD₂₁₂ | . . . | TD_{21M} | O₂₁ |
| TD₂₂₁ | TD₂₂₂ | . . . | TD_{22M} | O₂₂ |
| . . . | . . . | . . . | . . . | . . . |
| TD_{2N1} | TD_{2N2} | . . . | TD_{2NM} | O_{2N} |
| . . . | . . . | . . . | . . . | . . . |
| TD_{P11} | TD_{P12} | . . . | TD_{P1M} | O_{P1} |
| TD_{P21} | TD_{P22} | . . . | TD_{P2M} | O_{P2} |
| . . . | . . . | . . . | . . . | . . . |
| TD_{PN1} | TD_{PN2} | . . . | TD_{PNM} | O_{PN} |

Training examples can be grouped into training example sets 112, or “sets” for brevity, as illustrated in Table 2, containing P sets, each with N items in the set and M features per item. (Note that sets are not required to have the same number of items.) Each set can contain related training examples. For example, in the context of a recommendation system 170, results relevant to one query can be grouped into a set, and results related to a second query can be grouped into a different set. The system can store training example sets 112 in a data structure such as a hash map that uses a set identifier as a key and the training examples in the set as values associated with the corresponding key.

The training example obtaining engine 152 can provide the training examples 110 to a machine learning model training engine 155.

The machine learning model training engine 155 can be configured to train a machine learning model 120 (that is, a teacher model), such as a deep neural network, using the training example sets 112. The machine learning model training engine 155 can train the machine learning model 120 using supervised machine learning model training techniques as described below. Note that while this specification describes deep neural networks, other machine learning models, such as linear models, can also be used.

Once the teacher machine learning model 120 is trained, the distilled machine learning model training engine 160 can execute the trained teacher machine learning model 120 using training examples 110 (which can be the training examples used to train the trained machine learning model 120 or other training examples) assigned to training sets 112 to produce results 125 that are assigned to a result set 126. The system can store result sets 126 (where each result set is associated with the training set used to produce it) in a data structure such as a hash map that uses a result set identifier as a key and the results associated with training examples in the set as values associated with the corresponding key. The system can also use result sets 126 for analysis.

The distilled machine learning model training engine 160 can then use the training examples 110 and results 125 to train a distilled (student) machine learning model 130. The distilled machine learning model 130 can be any appropriate type of machine learning model, such as a neural network. Preferably, the distilled machine learning model 130 will require less computational resources to execute than does the machine learning model 120, and will execute faster. The distilled machine learning model 130, when executed using a training example 110, is configured to produce results 135 that approximate the results 125 produced by the machine learning model 120 on the training example 110 in both scores and rankings.

Once the distilled machine learning model 130 is trained, a model provider engine 165 can provide the trained distilled machine learning model for use by a recommendation system 170 or other systems that utilize such machine learning models.

The recommendation system 170 can include a distilled machine learning model acquisition engine 172, a distilled machine learning model evaluation engine 175 and a device interaction engine 180.

The distilled machine learning model acquisition engine 172 can acquire a distilled machine learning model 130 from a machine learning model training system 150 or from a repository configured to store distilled machine learning models. For example, the distilled machine learning model acquisition engine 172 can obtain the distilled machine learning model 170 (that is, the student model) from the machine learning model training system 150 over a network. In another example, the machine learning model training system 150 can push the distilled machine learning model 170 to the distilled machine learning model acquisition engine 172 after the model is trained.

The recommendation system 170 can then accept query requests 132 from one or more devices 185a-185n. Each query request can be a request for one or more recommended items. If the recommendation system 170 is located at a domain corresponding to a URL example.com, the query request can be of the form: https://www.example.com/?q=<query_request>. A query request can include components such as keywords (e.g., “football”, “pasta,” “road,” etc.), constraints (e.g., “search on site example.com,” “search for results after Jan. 1, 2020,” etc.) and so on. The query request can also include, as components, data describing the context for which the recommended items are being requested. For example, if the query request is for search results, the query request can include keywords of the query, the geographic location of the device submitting the query request, the time of day, the type of the device submitting the query request, etc. If the query request is for digital components, the query request can include the resource locator for the electronic resource with which the digital component(s) will be displayed, the number of digital component slots on the resource, etc.

The components of the request can be used as feature values, or used to generate corresponding features values, that are used by the recommendation system 170 to select one or more recommended items to provide in response to the query request. Returning to the drill bit example, the request could include features such as the type of material being drilled, desired drilling depth, drilling angle, etc.

A device interaction engine 180 within the recommendation system 170 can then accept query requests 132 from devices 185a-185n. Devices 185a-185n can be any type of network-capable computing device, including a desktop computer, laptop computer, mobile telephone, server computer, robotic environment, etc.

The device interaction engine 180 can receive the query request 132 over any appropriate networking protocol, such as Hypertext Transfer Protocol (HTTP) or HTTP-Secure (HTTPS).

In response to receiving a query request 132, the recommendation system 170 can invoke the distilled machine learning model evaluation engine 175 to execute the distilled machine learning model 130 against the query request 132, e.g., by providing feature values corresponding to the query request as input to the distilled machine learning model 130. The distilled machine learning model evaluation engine 175 can produce results 135 associated with the query request 132 and return the results 135 to the device 185.

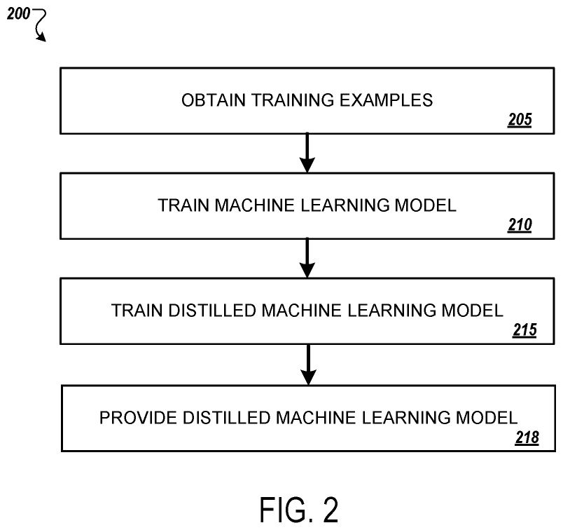

FIG. 2 is a flow diagram of an example process 200 for training and providing a distilled machine learning model. For convenience, the process 200 will be described as being performed by a machine learning model training system, e.g., the machine learning model training system 150 of FIGS. 1A and 1B, appropriately programmed to perform the process. Operations of the process 200 can also be implemented as instructions stored on one or more computer readable media which may be non-transitory, and execution of the instructions by one or more data processing apparatus can cause the one or more data processing apparatus to perform the operations of the process 200. One or more other components described herein can perform the operations of the process 200.

In operation 205, the system obtains training examples. Training examples can be obtained from a training example data store using any appropriate data retrieval method, such as structured query language (SQL) queries to retrieve data from a relational database, a file system requests to retrieve information from a file system, HTTP requests to retrieve data from a web server, and so on.

In operation 210, the system trains a machine learning model, and more specifically, a “teacher” machine learning model, or “teacher model,” for brevity. The teacher model can be trained using supervised machine learning model training techniques for training a machine learning model. The teacher model can train on different types of direct label losses, such as cross entropy, square loss or others on the actual label. It can also train in addition to or instead of the direct label loss with ranking losses such as cross entropy on labels that describe differences of true label between pairs, sets or lists of examples. When training on more than a single loss, the teacher trains on the sum of losses, and gradients emerge as sum of gradients of the different losses. Losses can be weighted with different weights emphasizing one loss over another. Weights can be ramped up or down during training. Weights can be tuned for best, or improved, empirical performance on the specific application. Once trained, the teacher machine learning model is configured to generate a set of scores for a training example set. The set of scores for a training example set includes, for each item in the training example set, a score that represents the likelihood that the item will have a positive outcome when presented in the content of the training example set and with each other item in the training example set. A positive outcome for an item, e.g., a digital component, can be an outcome that indicates that a particular action occurred with respect to the item when the item was selected for deployment to a device.

For example, for a neural network, a loss function can be computed by comparing the outcome predicted by executing the machine learning model against a training example to the actual outcome, such as the value Oᵢ shown in TABLE 1. In some implementations, the square of the loss computation is used. The loss function can then be used to train the neural network, for example, using stochastic gradient descent or mini-batch gradient descent.

In some implementations, the system can optionally continue to train the teacher model on presently arriving data examples. The system can provide predictions from the teacher mode to the student model in real time (that is, as the predictions are generated by the teacher model), and the student follows the training from the arriving examples with the newly-generated teacher prediction. In some implementations, the students can continue training on newly arriving data after stopping using the signal from the teacher.

In operation 215, the system trains a distilled machine learning model, or “distilled model,” for brevity. The training process is similar to the training process for the teacher model, except that the distilled model can train on four loss functions: (i) the true label; (ii) the distilled model score with the teacher model score; (iii) the ranking with the true label; and (iv) the pairwise and/or listwise score differences between examples within the same group. Any subset of the four loss functions can also be used, and other objectives can be also be used. The system can optimize, or attempt to optimize, a superposition (i.e., a weighted sum) of the selected losses—that is, all four losses or a selected subset. The system may include other losses and optimizes for all selected loss jointly. The system scales each loss by a configurable weight, and the student is optimized for a linear combination of these losses. Direct losses can be cross entropy, and distillation losses can be cross entropy, square losses, or others. The system can also compute cross entropy distillation.

The loss function for the true label can be computed by summing the square of the difference between the actual outcome scores (e.g., the values Si which are the logistic scores for the label prediction Oᵢ shown in TABLE 1) with the scores produced by the distilled model (Dᵢ):

$${\sum }_{i}^{N} {( {S}_{i} - {D}_{i} )}^{2} \qquad ( 1 )$$

Other losses, such as cross-entropy loss, can also be used.

In this equation, N is the number of training examples, and for each training example i, Sᵢ is the actual outcome score for the training example, and Dᵢ is the logit value produced by the distilled model when evaluating training example i. However, the actual true outcome label is either 1 or 0. Therefore, in practice, cross entropy can be used with the following loss:

$$L = - label * log ( p ) - ( 1 - label ) * log ( 1 - p ) \qquad ( 2 )$$

where p is the probability predicted by the model, label is the true label (e.g., actual result) of the example which is either 0 or 1.

When using logistic regressions, if s is the score in logit space, then

$$- log ( p ) = log ( 1 + {e}^{- s} ) and - log ( 1 - p ) = log ( 1 + {e}^{s} ) \qquad ( 3 )$$

If the distillation is on least squared error (L2) logits, the loss function for the distilled model score with the teacher model score is computed by summing, across all training examples, the square of the difference between the score computed by the teacher model for the training example and the score produced by the distilled model for the training example:

$${\sum }_{i}^{N} {( {T}_{i} - {D}_{i} )}^{2} \qquad ( 4 )$$

In equation (4), N is the number of training examples and for each training example i, Tᵢ is the teacher score output by the teacher model for the training example i, and Dᵢ is the score produced by the distilled model for the training example i.

In some implementations, loss can be computed using probability cross entropy, where the loss can be computed as:

$$L = - q log ( p ) \qquad ( 5 )$$

$$and$$

$$L = - ( 1 - q ) log ( 1 - p ) \qquad ( 6 )$$

In equations 5-7, q is the probability predicted by the teacher for the example and p is the probability predicted by the student,

$$q = Sigmoid ( T ) = 1 / ( 1 + {e}^{- T} ) \qquad ( 7 a )$$

$$and$$

$$p = Sigmoid ( D ) = 1 / ( 1 + {e}^{- D} ) \qquad ( 7 b )$$

The loss function for the ranking with the true label can be computed by comparing the relationships of the outcomes predicted by the distilled model with the true ranking relationships. If the true label of the first item is 1 and the true label of the second item is 0, then the direct ranking loss label is 1. If the true label of the second item is 1 and the true label of the first item is 0, then the direct ranking loss label is 0. If both items equal, the outcome label is 0.5. In some implementations, this case will be ignored for training the ranking loss, and ranking loss will only be trained on pairs for which the labels are different. The loss function can then be computed using logistic loss that compares the values for the computed ranking relationships (which will be a real number representing a prediction of a true label, to the true ranking relationships:

$${L}_{r a n k i n g} = {\sum }_{i = 1}^{N} {\sum }_{j = 1 , j \neq i}^{N} {y}_{ij} log [ 1 + {e}^{( {s}_{j} - {s}_{i} )} ] \qquad ( 8 )$$

where s_i and s_j are scores predicted by the model for item i and j, respectively, and y_{ij} is the label score in {0,0.5,1} computed as described above.

The loss function for the pairwise and/or listwise score differences between examples within the same group can be computed as explained below. As explained below, the listwise approach can be computed more quickly.

When ranking a list of examples, the pairwise framework can be simplified to a listwise approach. As above, a label for example i is positive if i has a positive outcome and all other j have a negative one, and 0 otherwise. If the labels of all N examples are equal, then yᵢ=1/N for all i.

In cases in which there are more than a single positive label with still negative labels, an approximation can be determined by assigning yᵢ=1/P to all P examples with positive labels, and 0 to all examples with negative ones. The loss then becomes cross entropy loss over a softmax prediction value based on the learned scores given by:

$${L}_{r a n k i n g} = - {\sum }_{i = 1}^{N} {y}_{i} log [ \frac{exp ( {s}_{i} )}{{\sum }_{j = 1}^{N} exp ( {s}_{j} )} ] = {\sum }_{i = 1}^{N} {y}_{i} log [ 1 + {\sum }_{j = 1 , j \neq i}^{N} exp ( {s}_{j} - {s}_{i} ) ] \qquad ( 9 )$$

where yᵢ in {0, 1/P, 1/N, 1} takes values as described. When N=2, the pairwise loss described above for a single pair is a special case of this loss. For larger N, the losses are not equal, but they still can optimize the score differences similarly to a function of the labels, converging to the same optima. Again, labels {0,1} can be used if there are no multiple positives in an example set, ignoring all sets in which all labels are equal to obtain a conditional ranking solution conditioned on the event that a single example (only) has a positive label. In some applications, such as online learning, this approach may still affect accuracy as discussed for pairwise loss.

In some cases, the loss in equation (9) will not generalize for example sets with multiple positive and negative labels. This result occurs since, for logistic regression, for the optimal solution, the empirical ratio of a positive label on some slice must match the average prediction on this slice. If 1 is used for any positive label, an example set is counted multiple times for each positive label. This approach will skew the optimal prediction for examples with negative labels. To correct that, 1/P label can be used for each of the P positive labeled examples in an example set. However, this will skew the empirical distribution of these positive examples, as each positive is counted as 1/P instead of as 1.

To address these skews, an additional alternative expansion of this methodology to the case in which more than a single positive label is expected in the example set is one that views the example labels as disjoint events, where a union of such events is an example set with more than a single positive label. Such a view gives 0 loss if all examples in the set have the same label. Using the same labels of yᵢ in {0, 1/P, 1/N, 1}, the softmax probability in the loss is a sum over all examples in the set that have the same label as the example which is currently processed. The ranking loss is then given by

$${L}_{r a n k i n g} = - {\sum }_{i = 1}^{N} {y}_{i} log [ \frac{{\sum }_{ℓ : {y}_{ℓ} = {y}_{i}} exp ( {s}_{ℓ} )}{{\sum }_{j = 1}^{N} exp ( {s}_{j} )} ] \qquad ( 10 )$$

In case of continuous labels, this loss equals the loss computing using equation (9). While this adjustment address the skewness of the loss in equation (9), it still has its own skewness for events in which all examples in an example set have the same label, where the loss is counted as 0.

### Pairwise L2 Ranking Distillation Loss

In the pairwise ranking distillation approach, a component of the knowledge that is transferred from teacher to student is the difference in scores between training example i and training example j, thus distilling the score differences and not the actual scores. This difference is computed pairwise on all training examples within a set of examples, which focuses rank differences on features that are different between elements in the set, as opposed to features that are the same, such as query-only features in a search system. In some implementations, pairwise rank differences can be included on examples within full training mini-batches of full batches instead of only on examples in the same set.

Such distillation can use regression that matches the difference learned by the student with differences learned by the teacher. Thus, distillation loss can be computed as a square loss between the score differences. Thus, the loss to optimize by the student is given by:

$${L}_{r a nking - distillation} = {\sum }_{1}^{N} {{\sum }_{j = 1 , j \neq i}^{N} [ ( {t}_{i} - {t}_{j} ) - ( {s}_{i} - {s}_{j} ) ]}^{2} \qquad ( 11 )$$

Where, in a set of N items, ti is the teacher logit score for item i and sⱼ is the student logit score for an item j. The N items can be related items (e.g., from a query) selected from a larger set of items and considered together.

The advantage of applying distillation on the square difference of scores instead of on probabilities is that distillation on the square difference of scores provides gradients that depend solely on the magnitude of the score differences in logit space, where with cross entropy this property is lost, and rates of convergence will be slower. Put differently, the L2 loss provides a strongly convex loss, whereas the cross entropy does not, so then convergence to the optimum value is faster with the strongly convex loss.

This factor allows a conventional stochastic gradient optimizer to adjust that distance uniformly and independently of the actual probabilities.

This definition can be viewed as a limit case of the general distillation framework when applied to the ranking problem. The loss in equation (1) can be also expressed as:

$${L}_{ranking - distillation} = {\sum }_{i = 1}^{N} {\sum }_{j = 1 , j \neq i}^{N} {[ ( {t}_{i} - {s}_{i} ) - ( {t}_{j} - {s}_{j} ) ]}^{2} \qquad ( 12 )$$

From this equation, it is apparent that if all teacher scores are shifted by the same amount from the student scores, the student rankings are still correct, and need not be updated.

This shift invariance provides a degree of freedom for an accuracy loss to improve label loss accuracy, independently of the ranking distillation loss. This is true since, when there are N items and the model constrains only differences between pairs, there are only N−1 independent equations. Any solution where all values are shifted by the same amount will satisfy all constraints. Therefore, the actual values have a degree of freedom, which can be learned by the direct loss. Put differently, if all examples in the set have two features (e.g., one query and one digital component), the examples will all have the same first feature (e.g., query feature), but a different second features (e.g., digital component features). Ranking will subtract one set of features from the other, and will solely be based on the second (e.g., digital component) feature. Therefore, the direct loss can be used to determine the value of the first (e.g. query) feature, which is the same for all second (e.g., digital component) features.

A direct square loss between the student model score and teacher model score on the same item may not provide such freedom, and thus forces the student model scores towards matching the teacher model score. When the intent is only to distill ranking from the teacher to student, such a loss imposes a larger constraint-that is, the student scores for the student will be forced to match the scores of the teacher model.

Moreover, if the student scores are considered a combination of feature weights, some scores specific to an example and other scores specific to an example set containing the example, then distilling square loss directly will typically include an update to the gradients of features common to all examples in the set (e.g., in query systems, the query-only features) and features that are specific to an example in the set. Distilling square loss on differences, on the other hand, will have nonzero total set gradients only for features that distinguish between different examples in the set, For example, one can consider a case where all examples in a set consists of two features: Ai (digital component feature/) and Q, where Q is equal to all items. Therefore:

$${S}_{i} - {S}_{j} = ( {A}_{i} + Q ) - ( {A}_{j} + Q ) = {A}_{i} - {A}_{j} \qquad ( 13 )$$

Thus, the difference for item i and item j is a function only of the digital component feature, and not of the query feature, which is common to all digital components. Since ranking in the query is solely of interest, then Q, which has no effect on it, need not be updated as it is accounted for by the difference loss. L2 loss on the scores will not ensure that outcome, especially where learning rates and gradients are different per coordinate. Therefore, losses that are not directly geared towards score differences will be updating feature Q as well, but feature Q gives no information about ranking within the example set.

This advantage is lost when distilling directly between the teacher model and the student model since, if the actual score is distilled instead of the difference, it is not the case that feature Q does not learn when it should not be learning. For ranking examples in a set, the approach of a distillation difference loss results in an advantageous outcome: improving ranking within a set (or a query) is accomplished by learning the weights of per example features that differ between the different examples, and avoiding updating features that are common to all examples in the set (e.g., in a query system, query-only features). The approaches described below that replace the square L2 loss by distillation in probability also produce this property, but lack the other desired property of gradients that depend only on the distance of the score differences between the student model and the teacher model, which gives uniform behavior across different prediction probabilities.

### Listwise Implementation of L2 Ranking Distillation Loss

Implementing the pairwise ranking loss as it is described previously above can involve O(N)² operations. However, equation (12) can be rewritten to open the square terms, leading to a more efficient implementation—that is, one that requires fewer processor instructions to complete and that can be completed faster. Note that the listwise loss derived for distillation is the same loss used in the pairwise approach, but expressed in a different form. For square distillation loss, let

$$T = {\sum }_{i = 1}^{N} {t}_{i} , S = {\sum }_{1}^{N} {s}_{i} \qquad ( 14 )$$

be the sums of the logit scores of both teacher and student, respectively, for all N items in an example training set. Applying the simplification described above gives a ranking loss of:

$${L}_{ranking - distillation} = 2 N {\sum }_{i = 1}^{N} {( {t}_{i} - {s}_{i} )}^{2} - 2 {( T - S )}^{2} \qquad ( 15 )$$

Thus, to determine L2 ranking distillation, either pairwise or on a list, the loss can be computed as in above equation (15), and gradients can be derived accordingly. For a set, the sum of scores is computed for both teacher and student, and the above equation (15) is applied. The gradient of the loss with respect to score sₖ can be computed using equation 16.

$$\frac{\partial {L}_{ranking - distillation}}{\partial {s}_{k}} = 4 N ( {s}_{k} - {t}_{k} ) + 4 ( T - S ) \qquad ( 16 )$$

In this example, the gradients with respect to scores sₖ, k in {1, 2, . . . , N} can be computed together using only O (N) operations.

A property of the gradient is that if sₖ is on one side of tₖ, the gradient pushes sₖ toward tₖ. If sⱼ (j≠k) is on the same side of ti as sₖ of tₖ, the influence of the j^{th} example on the gradient of sₖ pushes in the opposite direction. This result is expected as the loss typically enhances differences of different examples. In both pairwise and listwise cases, the method relies on the fact that the teacher is already optimized for the rank loss which is distilled. Therefore, if the teacher is optimized for pairwise loss, then L2 ranking distillation will produce more accurate pairwise loss. The distillation form relies on matching pair differences, which are the optimized statistic in the direct listwise loss, so it is also useful for the listwise case. As described above, direct pairwise and listwise losses have different values, but both optimize the difference of scores.

With at least some of the four computed loss components—(i) the true label; (ii) the distilled model score with the teacher model score; (iii) the ranking with the true label; and (iv) the pairwise and/or listwise score differences between examples within the same group-computed, the system can train the student model. The system can perform the training by using, for example, stochastic gradient descent or mini-batch stochastic gradient descent. Note that training can occur with all of the four losses, any subset of these four losses, or other loss types. Importantly, in this specification, distillation ranking loss is included, and the model is trained with a weighted sum of losses, including the ranking distillation loss, optionally including all or some of the other loss types. The ranking distillation loss emphasizes the ranking scores as important, and can provide improvements in ranking if the teacher's rankings are accurate.

Ranking distillation can be combined with techniques, such as LambdaRank, where the rank of examples in a pair on which the loss is applied is used to scale (or discount) the loss of some ranks. For example, if rᵢ denotes the absolute ranking of example i in the set, then element (i,j) of the pairwise loss can be discounted by applying a multiplier:

$$\frac{1}{D ( {r}_{i} )} - \frac{1}{D ( {r}_{j} )} \qquad ( 17 )$$

where D(x) is an inverse discount function that can be equal to the rank, to the log (rank+1), or to another increasing function of the rank. More generally, ranking distillation can be combined with other methods that enhance or discount loss components based on relative or absolute ranking.

Alternatively, a function inverse in the relative ranking, for example,

$$1 / {( {r}_{i} - {r}_{j} )}^{α} \qquad ( 18 )$$

where alpha >0 is an exponent, can be used. In the distillation setting, this technique can be applied according to the ranking of the teacher, of the student, or a combination of both. Using such a method may be justified in settings where some scoring (such as document relevance scoring, or revenue based scoring) gives more weight to higher ranked items. An alternative can include adding weighting by functions of the score instead of the ranking, including Softmax scoring of logit scores for weighting.

In some implementations, the system can optionally train the student model with presently arriving data examples. In these cases, the system trains the student model without additional information from the teacher. (This approach can be beneficial due to resource or system design constraints.)

Various alternatives can also be used and are appropriate in certain circumstances. For example, using distillation square loss between score differences can be justified if the teacher has much superior knowledge of ranking than the student, and the objective goal is to make the student's differences as close as possible those of the teacher. As shown below, this approach can be a limit case of temperature-based distillation on the score differences at high temperatures.

Before demonstrating that approach, this specification shows that it is possible to distill in probability, where probability is defined, as discussed above, as the probability of item i having a label of higher value than item j. As mentioned previously, the disadvantage of distilling in probability is that it forces non-uniform gradients as a function of the score difference. If the score difference for a positive label is a large negative number (e.g., −3 or a more negative number) gradients are capped at 1, and recovery from incorrect ranking may be slower. Conversely, sometimes it is more appropriate to keep changes in the model smaller for every update (for example, to guarantee model training stability).

### Pairwise Probability Ranking Distillation

### Direct (Unconditional) Pairwise

Pairwise probability ranking distillation can be performed by defining a distillation loss as that of equation (19), where the label is given as the logistic (Sigmoid) function of the teacher's score difference.

$${y}_{ij} = {q}_{ij} {=}^{△} σ ( {t}_{i} - {t}_{j} ) {=}^{△} \frac{1}{1 + ( exp ( {t}_{j} - {t}_{i} )} \qquad ( 19 )$$

The student simply learns towards the teacher's labels.

### Conditional Pairwise Distillation

Considering loss for conditional distribution only, conditioned for each pair on the event in which the labels of the pair are not equal (one positive, one negative), one can take an approach that the probability of a teacher score of an example is its Sigmoid. Thus, the teacher label (yᵢ) of example i can be computed using equation 20.

$${y}_{i} = {q}_{i} {=}^{△} \frac{1}{1 + ( exp ( - {t}_{i} )} \qquad ( 20 )$$

For pair (i, j) with probabilities qᵢ>qⱼ, the expected number of examples for which the label for i is ranked higher than the label of j is qᵢ-qᵢ=yᵢ-yᵢ. A loss that thus rely only on ranking differences can distill the student towards the difference label using equation 21.

$${L}_{ranking - diff - distillation} = {\sum }_{i = 1}^{N} {\sum }_{j = 1 , {y}_{j} < {y}_{i}}^{N} ( {y}_{i} - {y}_{j} ) log [ 1 + exp ( {s}_{j} - {s}_{i} ) ] \qquad ( 21 )$$

Similarly to direct ranking losses, while this loss encourages the ranking of the student to match that of the teacher, it may not be ideal when label probability predictions are also desired to be accurate, because in expectation it ignores events in which labels are equal, thus making predictions rely on fewer examples, and generally in an online AdaGrad setting, applying fewer but larger updates.

### Listwise Probability Ranking Distillation

Similarly, a listwise ranking distillation in probability loss can use equation 22.

$$( 22 )$$

$${L}_{ranking} = - {\sum }_{i = 1}^{N} {y}_{i} log [ \frac{exp ( {s}_{i} )}{{\sum }_{i = 1}^{N} exp ( {s}_{j} )} ] = {\sum }_{i = i}^{N} {y}_{i} log [ 1 + {\sum }_{j = 1 , j \neq i}^{N} exp ( {s}_{j} - {s}_{i} ) ]$$

for which yᵢ is defined as the Softmax probability of the teacher's scores using equation 23.

$${y}_{i} = {q}_{i} {=}^{△} \frac{exp ( {t}_{i} )}{{\sum }_{j = 1}^{N} exp ( {t}_{j} )} \qquad ( 23 )$$

Again, the student learns with the loss of equation (9) towards the teacher's labels.

### General Temperature Based Rank Distillation

It is also possible to use a temperature distillation approach for ranking by adding a temperature, gamma, to scale scores up or down. To offset the loss to the same scale described previously, the loss must also be scaled by the temperature (otherwise, with a stochastic gradient methods optimizer, the learning rates are changed). This gives a pairwise loss shown in equation 24.

$${L}_{temperature - ranking - distillation} = {\sum }_{i = 1}^{N} {\sum }_{j = 1 j \neq i}^{N} \frac{γ}{1 + exp [ \frac{1}{γ} ( {t}_{j} - {t}_{i} ) ]} \cdot log [ 1 + exp [ \frac{1}{γ} ( {s}_{j} - {s}_{i} ) ] ] \qquad ( 24 )$$

This also gives a listwise loss shown in equation 25.

$${L}_{temperature - ranking - distillation} = {\sum }_{i = 1}^{N} \frac{γ \cdot exp ( {t}_{i} / γ )}{{\sum }_{j = 1}^{N} exp ( {t}_{j} / γ )} \cdot log [ \frac{exp ( {s}_{i} / γ )}{{\sum }_{j = 1}^{N} ( exp ( {s}_{j} / γ )} ] \qquad ( 25 )$$

The effect of the temperature parameter is to stretch (or shrink) the x-axis reversed Sigmoid gradient (in the pairwise case, and similarly in the listwise case), giving a wider linear region with gamma>1 to the gradient as function of the score difference. This allows closer to uniform update movements in a larger region of the score differences (sᵢ−sⱼ). (The slope of the change in gradients decreases). If gamma<1, this shrinks the linear change in gradient region, giving larger gradients earlier, allowing faster recovery from largely incorrect ranking, which slows down quickly as ranking is closer to neutral. With a high gamma, this technique approaches square (L2) distillation (scaled by 0.5, where scaling can be offset when learning rates are adjusted).

### Distilling for Ranking Only-Rank Correlation

Consider a case in which a training data rich complex teacher model that was only trained for ranking (and its ranking positions are trusted, not scores), or alternatively only ranking are important and not proper scores. Distillation can occur with a square loss between the ranking uᵢ by the teacher, and that of the student, denoted by n, where both rankings are permutations of {1, 2, . . . , N}, depending on the rankings of the logit scores of both models. This can be done using a square rank loss as shown in equation 26.

$${L}_{ranking - only - distillation} = {\sum }_{i = 1}^{N} {( {u}_{i} - {r}_{i} )}^{2} \qquad ( 26 )$$

Minimizing this loss as identical to maximizing Spearman's rank correlation between the teacher and the student. Such minimization can be achieved by obtaining some mapping between ranking and scores, on which gradients can be computed. Alternatively, the student scores can take steps proportional to the gradient of the loss with respect to the student's ranking n of the example, or a gradient of the sign of this ranking.

In operation 218, the system provides the trained, distilled machine learning model, for example, to a recommendation system that distributes items, e.g., digital components. The system can provide distilled machine learning model by transferring it over a network, for example, using HTTP or TCP/IP, or by storing the trained distilled machine learning model in a repository such as a database or file system where it can be accessed, for example, by a recommendation system.

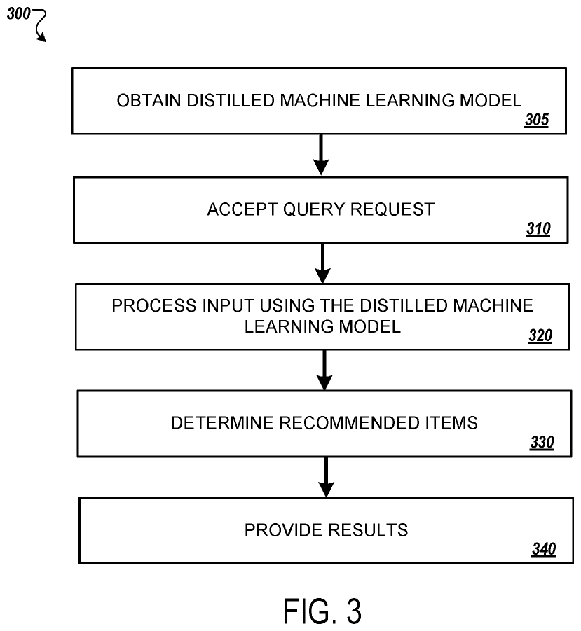

FIG. 3 is a flow diagram for an example process 300 for providing results to a query using a distilled machine learning model. For convenience, the process 300 will be described as being performed by a recommendation system, e.g., the recommendation system 170 of FIGS. 1A and 1B, appropriately programmed to perform the process. Operations of the process 300 can also be implemented as instructions stored on one or more computer readable media which may be non-transitory, and execution of the instructions by one or more data processing apparatus can cause the one or more data processing apparatus to perform the operations of the process 300. One or more other components described herein can perform the operations of the process 300.

In operation 305, the system obtains a distilled machine learning model. In some implementations, the system can obtain the model by accepting a transfer from a machine learning model training system. Such a transfer can use an appropriate networking protocol such as HTTP or File Transfer protocol (FTP). In some implementations, the system can acquire the model by retrieving it from a repository, for example, by using a SQL query to retrieve it from a database, using file system operations to retrieve the model from file storage, or HTTP to retrieve the model from a web server.

In operation 310, the system accepts a query request that includes data describing the context for the recommended items, which are then used as the feature values input to the distilled machine learning model. The system can accept the query request over any suitable networking protocol such as HTTP or HTTPS. As described above, if the recommendation system is located at URL xyz.com, the query request can be of the form: https://www.example.com/?q=<query_request>. The system can parse the query using any conventional HTTP request parser, which, in this example, will locate the query request after the equal sign.

In operation 320, the system then processes input that is based at least in part on the feature values using the trained, distilled machine learning model. Processing the input can use convention model evaluation technologies that depend on the type of machine learning model used. For a deep neural network, the system encodes the query request as a series of numbers, each number corresponding to a word, that are used as input to the neural network. The neural network then evaluates each node using the weights and biases learned during the training process of operation 215. The result of evaluating the neural network is a series of scores produced by evaluating the input using the distilled machine learning model, with each score corresponding to a recommended item.

In operation 330, the system determines the recommended items to provide to client devices using the scores produced in operation 320. The system can select a configured number of recommended items, and specifically the items that have the highest scores produced in operation 320. Alternatively, the system can select all recommended items that have a score that exceeds a configured threshold.

In operation 340, the system provides the results to the requester, such as a requester associated with a client device. The results can be encoded as an HTTP response using conventional techniques.

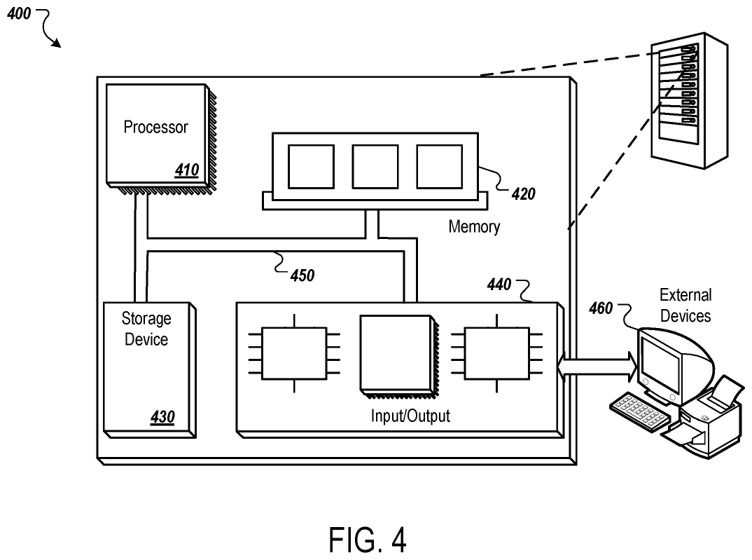

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 460, e.g., keyboard, printer and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
obtaining a first input comprising a plurality of training example sets that each include, for a set of items, one or more feature values that represent features of a context in which each item in the set of items were recommended and, for each item, an outcome label that represents whether the item had a positive outcome;
training, using the first input, a first machine learning model that is configured to generate a set of scores for each training example set, wherein the set of scores for each training example set comprises, for each item in the training example set, a training score that represents whether the item will have a positive outcome when presented in the context of the training example set and with each other item in the example set; and
training, using the set of scores for each example set, a distilled machine learning model that is configured to generate, for each item in an actual set of items, a distilled score that represents: (i) whether the item will have a positive outcome when presented in a given context and with each other item in the actual set of items, and (ii) the ranking of the item in the actual set of items,
wherein a positive outcome for an item indicates that a particular action occurs with respect to the item when the item is provided to a device as a recommendation.

Embodiment 2 is the method of embodiment 1, where each item comprises a digital component.

Embodiment 3 is the method of embodiment 2 further comprising:
providing, by a training system, the distilled model to a recommendation system that distributes digital components;
determining, by the recommendation system, digital components to provide to client devices in response to requests received from the client devices; and
providing, by the recommendation system, the selected digital components to the client devices.

Embodiment 4 is the embodiment of claim 1, where the distilled machine learning model is trained using:
for each item of the plurality of training example sets: (i) a true label corresponding to the outcome label for the item; (ii) a comparison between a distilled model score for the item with a teacher model score for the item; and (iii) a comparison between a ranking of the item among the items of the plurality of training example sets with the true label for each item; and
item-wise score differences between training examples within a same training example set.

Embodiment 5 is the method of embodiments 1 to 4, wherein training the distilled machine learning model comprises:
determining item-wise score differences between training examples within a same training example set; and
minimizing a loss corresponding to the item-wise score differences.

Embodiment 6 is the method of embodiments 1 to 5 wherein training the distilled machine learning model comprises determining each item-wise score difference, the determining comprising:
for each pair of items in the same training example set:
   determining a first difference between a first teacher model score for a first item of the pair of items and a second teacher model score for a second item of the pair of items;
   determining a second difference between a first distilled model score for the first item and a second distilled model score for the second item of the pair of items; and
   determining, as the item-wise score difference for the pair of items, a difference between the first difference and the second difference.

Embodiment 7 is the embodiment of claim 5, wherein the loss is L2 loss.

Embodiment 8 is the method of embodiment 6 wherein training the distilled machine learning model comprises reducing an aggregate of the item-wise score differences for each training example set.

Embodiment 9 is the method of embodiment 5, wherein training the distilled machine learning model comprises determining item-wise score differences, the determining comprising:
for a first item in a list of items in the same training example set:
   for each second item in a list of items in the same training example set where the first item is different from the second item:
      determining a first difference between a first teacher model score for a first item and a second teacher model score for the second item;
      determining a second difference between a first distilled model score for the first item and a second distilled model score for the second; and determining a individual loss value based on the first difference and the second difference; and
determining the list-wise loss value based on the individual loss values.

Embodiment 10 is the method of embodiment 9, wherein training the distilled machine learning model comprises reducing an aggregate of the list-wise loss values for each training example set.

Embodiment 11 is the method of any of embodiments 5 to 10, wherein each item-wise score difference is a pairwise score difference or a listwise score difference.

Embodiment 12 is the method of embodiment 4, wherein training the distilled machine learning model comprises computing, as a loss function, a summing, across all items of the plurality of training example sets, a square of a difference between losses computed for the item.

Embodiment 13 is the method of embodiment 4, wherein training the distilled machine learning model comprises determining a loss function, based on, for each item of the plurality of training example sets, a comparison between an outcome for the item predicted by the distilled model and an actual outcome for the item represented by the outcome label for the item.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining a first input comprising a plurality of training example sets that each include, for a set of items, one or more feature values that represent features of a context in which each item in the set of items were recommended and, for each item, an outcome label that represents whether the item had a positive outcome;
training, using the first input, a first machine learning model that is configured to generate a set of scores for each training example set, wherein the set of scores for each training example set comprises, for each item in the training example set, a training score that represents whether the item will have a positive outcome when presented in the context of the training example set and with each other item in the example set; and
training, using the set of scores for each example set, a distilled machine learning model that is configured to generate, for each item in an actual set of items, a distilled score that represents: (i) whether the item will have a positive outcome when presented in a given context and with each other item in the actual set of items, and (ii) the ranking of the item in the actual set of items,
wherein a positive outcome for an item indicates that a particular action occurs with respect to the item when the item is provided to a device as a recommendation.

2. The computer-implemented method of claim 1, where each item comprises a digital component.

3. The computer-implemented method of claim 2, further comprising:
providing, by a training system, the distilled model to a recommendation system that distributes digital components;
determining, by the recommendation system, digital components to provide to client devices in response to requests received from the client devices; and
providing, by the recommendation system, the selected digital components to the client devices.

4. The computer-implemented method of claim 1, wherein the distilled machine learning model is trained using:
for each item of the plurality of training example sets: (i) a true label corresponding to the outcome label for the item; (ii) a comparison between a distilled model score for the item with a teacher model score for the item; and (iii) a comparison between a ranking of the item among the items of the plurality of training example sets with the true label for each item; and
item-wise score differences between training examples within a same training example set.

5. The computer-implemented method of claim 1, wherein training the distilled machine learning model comprises:
determining item-wise score differences between training examples within a same training example set; and
minimizing a loss corresponding to the item-wise score differences.

6. The computer-implemented method of claim 1, wherein training the distilled machine learning model comprises determining each item-wise score difference, the determining comprising:
for each pair of items in the same training example set:
determining a first difference between a first teacher model score for a first item of the pair of items and a second teacher model score for a second item of the pair of items;
determining a second difference between a first distilled model score for the first item and a second distilled model score for the second item of the pair of items; and
determining, as the item-wise score difference for the pair of items, a difference between the first difference and the second difference.

7. The computer-implemented method of claim 5, wherein the loss is L2 loss.

8. The computer-implemented method of claim 6, wherein training the distilled machine learning model comprises reducing an aggregate of the item-wise score differences for each training example set.

9. The computer-implemented method of claim 5, wherein training the distilled machine learning model comprises determining item-wise score differences, the determining comprising:
for a first item in a list of items in the same training example set:
for each second item in a list of items in the same training example set where the first item is different from the second item:
determining a first difference between a first teacher model score for a first item and a second teacher model score for the second item;
determining a second difference between a first distilled model score for the first item and a second distilled model score for the second; and
determining a individual loss value based on the first difference and the second difference; and
determining the list-wise loss value based on the individual loss values.

10. The computer-implemented method of claim 9, wherein training the distilled machine learning model comprises reducing an aggregate of the list-wise loss values for each training example set.

11. The computer-implemented method of claim 5, wherein each item-wise score difference is a pairwise score difference or a listwise score difference.

12. The computer-implemented method of claim 4, wherein training the distilled machine learning model comprises computing, as a loss function, a summing, across all items of the plurality of training example sets, a square of a difference between losses computed for the item.

13. The computer-implemented method of claim 4, wherein training the distilled machine learning model comprises determining a loss function, based on, for each item of the plurality of training example sets, a comparison between an outcome for the item predicted by the distilled model and an actual outcome for the item represented by the outcome label for the item.

14. A system comprising:
one or more processors; and
one or more storage devices storing instructions that, when executed by the one or more processors, cause the one or more processors to perform operations comprising:
obtaining a first input comprising a plurality of training example sets that each include, for a set of items, one or more feature values that represent features of a context in which each item in the set of items were recommended and, for each item, an outcome label that represents whether the item had a positive outcome;
training, using the first input, a first machine learning model that is configured to generate a set of scores for each training example set, wherein the set of scores for each training example set comprises, for each item in the training example set, a training score that represents whether the item will have a positive outcome when presented in the context of the training example set and with each other item in the example set; and
training, using the set of scores for each example set, a distilled machine learning model that is configured to generate, for each item in an actual set of items, a distilled score that represents: (i) whether the item will have a positive outcome when presented in a given context and with each other item in the actual set of items, and (ii) the ranking of the item in the actual set of items,
wherein a positive outcome for an item indicates that a particular action occurs with respect to the item when the item is provided to a device as a recommendation.

15. (canceled)

16. (canceled)

17. The system of claim 14, where each item comprises a digital component.

18. The system of claim 17, wherein the operations comprise:
providing, by a training system, the distilled model to a recommendation system that distributes digital components;
determining, by the recommendation system, digital components to provide to client devices in response to requests received from the client devices; and
providing, by the recommendation system, the selected digital components to the client devices.

19. The system of claim 14, wherein the distilled machine learning model is trained using:
for each item of the plurality of training example sets: (i) a true label corresponding to the outcome label for the item; (ii) a comparison between a distilled model score for the item with a teacher model score for the item; and (iii) a comparison between a ranking of the item among the items of the plurality of training example sets with the true label for each item; and
item-wise score differences between training examples within a same training example set.

20. The system of claim 14, wherein training the distilled machine learning model comprises:
determining item-wise score differences between training examples within a same training example set; and
minimizing a loss corresponding to the item-wise score differences.

21. The system of claim 14, wherein training the distilled machine learning model comprises determining each item-wise score difference, the determining comprising:
for each pair of items in the same training example set:
determining a first difference between a first teacher model score for a first item of the pair of items and a second teacher model score for a second item of the pair of items;
determining a second difference between a first distilled model score for the first item and a second distilled model score for the second item of the pair of items; and
determining, as the item-wise score difference for the pair of items, a difference between the first difference and the second difference.

22. A non-transitory computer readable storage medium carrying instructions that, when executed by one or more processors, cause the one or more processors to perform operations comprising:
obtaining a first input comprising a plurality of training example sets that each include, for a set of items, one or more feature values that represent features of a context in which each item in the set of items were recommended and, for each item, an outcome label that represents whether the item had a positive outcome;
training, using the first input, a first machine learning model that is configured to generate a set of scores for each training example set, wherein the set of scores for each training example set comprises, for each item in the training example set, a training score that represents whether the item will have a positive outcome when presented in the context of the training example set and with each other item in the example set; and
training, using the set of scores for each example set, a distilled machine learning model that is configured to generate, for each item in an actual set of items, a distilled score that represents: (i) whether the item will have a positive outcome when presented in a given context and with each other item in the actual set of items, and (ii) the ranking of the item in the actual set of items,
wherein a positive outcome for an item indicates that a particular action occurs with respect to the item when the item is provided to a device as a recommendation.
